(19) United States
(12) Patent Application Publication
(10) Pub. No.: US 2023/0115244 A1
(43) Pub. Date: Apr. 13, 2023

(54) AUTOMATED FEED SYSTEM

(71) Applicant: Iwaki America Incorporated, Holliston, MA (US)

(72) Inventors: Robert J. Torcellini, Eastford, CT (US); Gregory M. Driscoll, Eastford, CT (US); John P. Miersma, Whitinsville, MA (US); Christopher Collins, Mendon, MA (US); William Lane Peacock, Amesbury, MA (US); Eric Alan Moore, Pomfret Center, CT (US)

(21) Appl. No.: 17/965,013

(22) Filed: Oct. 13, 2022

Related U.S. Application Data
(60) Provisional application No. 63/255,275, filed on Oct. 13, 2021.

(51) Int. Cl. A01K 61/85

(52) U.S. Cl. CPC A01K 61/85

(57) ABSTRACT

An automated system for administering food to laboratory animals housed in aquatic tanks includes a plurality of individual feeding units that independently communicate with a common feed management hub. Each feeding unit includes a rack for holding a collection of aquatic tanks and a wireless robotic feeder configured to move in three dimensions relative to the rack. The robotic feeder precisely meters and delivers liquid and/or dry food to each rack-mounted tank in accordance with user-modifiable feed schedules which are maintained by the feed management hub. To compensate for any adjustments to the particular arrangement of tanks within a feeding unit, the robotic feeder periodically scans the rack for tanks and transmits the scan data back to the feed management hub. Accordingly, the feed management hub ensures that the proper type of food is accurately and timely delivered to each aquatic tank in compliance with the stored feed schedules.

### CROSS-REFERENCE TO RELATED APPLICATIONS

The present invention claims the benefit under 35 U.S.C. 119(e) to U.S. Provisional Patent Application No. 63/255,275, which was filed on Oct. 13, 2021, in the names of Robert J. Torcellini et al., the disclosure of which is incorporated herein by reference.

### FIELD OF THE INVENTION

The present invention relates generally to the field of scientific research and, more particularly, to automated feed systems for laboratory animals housed in rack-mounted aquatic tanks.

### BACKGROUND OF THE INVENTION

As a part of scientific research, aquatic organisms are routinely studied and modeled. Certain species of aquatic animals, such as zebrafish and xenopus, have been found to be instrumental in achieving technological breakthroughs in the fields of, inter alia, genetic research and drug development.

Traditionally, aquatic organisms are housed in aquatic tanks that are molded from plastic in specified volumes (e.g., 2-liter, 4.5-liter, and 9-liter tanks). Each size tank is determined to safely house a maximum capacity of a particular type of aquatic animal. In this manner, each tank is effectively designed to ensure a suitable environment for the organisms housed therein.

To minimize the overall footprint of the space required to maintain a supply of aquatic laboratory animals, a multitude of aquatic tanks is typically stored on a common vertical rack, or frame. Each rack is typically constructed of a rigid and durable material, such as stainless steel, and includes a plurality of open, horizontal shelves on which the aquatic tanks are mounted in a side-by-side relationship. As such, a large quantity of tanks can be stored within a relatively small area, thereby optimizing the efficiency of the usable laboratory space.

Conventionally, laboratory animals housed in aquatic tanks are fed by hand at defined time intervals by designated personnel associated with the laboratory, such as research scientists and assistants. Due to the rising number of aquatic animals commonly housed in laboratory environments, the manual feeding process required to sustain such a large quantity of organisms has become increasingly labor intensive and time consuming.

As a consequence, automated systems for the distribution of food to laboratory animals retained in rack-mounted aquatic tanks have been developed and implemented in laboratory settings. For example, in U.S. Pat. No. 8,499,719 to M. Brocca et al., the disclosure of which is incorporated by reference, an automated system for controlled distribution of substances to animal containment devices in an animal housing facility is described. In the '719 patent, a metal support structure is fixedly disposed in relation to an aquatic tank rack. Additionally, a dosing device is designed to travel along the support structure in order to dispense food into each tank in compliance with user-specified controls.

Although known in the art, traditional feed systems of the type as described above been found to suffer from a number of notable shortcomings.

As a first shortcoming, traditional feed systems are typically designed to distribute food to a limited number and fixed arrangement of aquatic tanks. In particular, such systems are not adequately designed to compensate for the frequent removal, repositioning, and/or addition of tanks from a rack during the course of regular scientific research. Additionally, conventional feed systems are not readily scalable and therefore cannot support any significant increase in automated tank feeding requirements.

As a second shortcoming, traditional feed systems are typically designed with limited user controls and functionalities. In particular, conventional feed systems are commonly regulated through user controls in direct connection with the dispensing device. Furthermore, most prior art feed systems are restricted in their ability to implement and modify programmed feed schedules. Lastly, conventional feed systems are incapable of supporting the ability for supervisory personnel to oversee and monitor feeding operations to ensure proper feed schedule compliance.

As a third shortcoming, traditional feed systems are often mechanically complex, thereby rendering such systems both labor intensive and expensive to install. Additionally, the movable dosing device is typically supplied with power through an electrical tether, which can create a physical encumbrance and resultant spatial limitations.

As a fourth shortcoming, traditional feed systems commonly experience imperfections in food distribution due to inherent mechanical inaccuracies. Most notably, the presence of calibration and registration errors often results in the spillage of food during the distribution process, thereby compromising the overall effectiveness of the system. Also, it has been found that food is often improperly metered by the dosing device and, as a result, an improper quantity of the food is ultimately dispensed.

### SUMMARY OF THE INVENTION

In view thereof, it is an object of the present invention to provide a novel automated feed system for laboratory animals housed in rack-mounted aquatic tanks.

It is another object of the present invention to provide an automated feed system of the type as described above which automatically compensates for modifications to the number and relative position of the rack-mounted aquatic tanks.

It is yet another object of the present invention to provide an automated feed system of the type as described above which includes enhanced user controls for implementing, modifying, and monitoring programmed feed schedules.

It is still another object of the present invention to provide an automated feed system of the type as described above which has a limited number of parts, is inexpensive to manufacture, is easy to install, has a limited physical footprint, and is readily scalable.

It is yet still another object of the present invention to provide an automated feed system of the type as described above which properly doses and accurately distributes food to the rack-mounted aquatic tanks in compliance with programmed feed schedules.

Accordingly, as one feature of the present invention, there is provided a system for automatically dispensing food into a plurality of aquatic tanks, the system comprising (a) a plurality of feeding units, each feeding unit comprising (i) a rack assembly adapted to support a set of the plurality of aquatic tanks in a modifiable arrangement, (ii) a unit controller mounted on the rack assembly, and (iii) a robotic feeder in wireless communication with the unit controller, the robotic feeder being adapted to move relative to the rack assembly and dispense food into a selection of the set of the plurality of aquatic tanks at specified time intervals in accordance with at least one feed schedule, and (b) a feed management hub in communication with the unit controller for each of the multi-tank feeding units, (c) wherein the feed management hub maintains the at least one feed schedule to be implemented by the robotic feeder for each of the plurality of feeding units.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a schematic diagram of an automated feed system for laboratory animals housed in rack-mounted aquatic tanks, the automated system being constructed according to the teachings of the present invention;

FIG. 2 is an enlarged front view of one of the multi-tank feeding units shown in FIG. 1;

FIGS. 3(a)-3(c) are front perspective, rear perspective, and top perspective views, respectively, of selected components of the multi-tank feeding unit shown in FIG. 2;

FIG. 4 is a front perspective view of the selected components of the multi-tank feeding unit shown in FIG. 3(a), the robotic feeder being shown with its cover removed therefrom to illustrate certain internal components;

FIG. 5 is a rear perspective view of the selected components of the multi-tank feeding unit shown in FIG. 3(c), the robotic feeder being shown with the liquid food canister removed therefrom to illustrate certain internal components;

FIG. 6 is an exploded, left side, perspective view of the dry food dispenser shown in FIG. 3(b);

FIGS. 7(a) and 7(b) are fragmentary, top perspective views of the multi-tank feeding unit shown in FIG. 2 at various stages during the process of recharging the robotic feeder;

FIGS. 8(a)-8(c) are fragmentary, top plan views of the multi-tank feeding unit shown in FIG. 2 at various stages during the displacement of the robotic feeder relative to an aquatic tank immediately prior to a food dispensing operation;

FIGS. 9(a) and 9(b) are exploded, left side, perspective views of the multi-tank feeding unit shown in FIG. 2 at various stages during Z-directional displacement of the support bracket immediately prior to a food dispensing operation; and

FIGS. 10(a)-10(f) are a series of sample screen displays for the software platform which enables the user in FIG. 1 to monitor and control multiple individual feeding units via the feed management hub.

### DETAILED DESCRIPTION OF THE INVENTION

### Automated Feed System 11

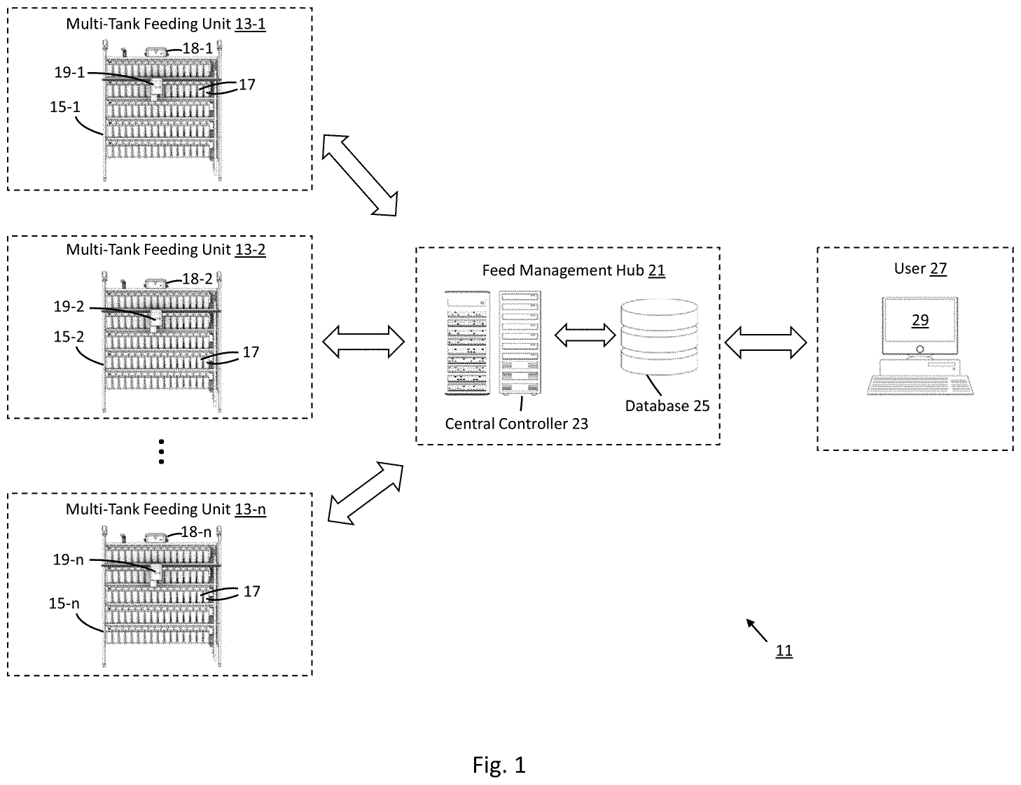

Referring now to FIG. 1, there is shown a schematic diagram of an automated feed system for laboratory animals housed in rack-mounted aquatic tanks, the system being constructed according to the teachings of the present invention and identified generally by reference numeral 11. As will be explained in detail below, system 11 provides an automated feed solution that is readily scalable, includes comprehensive food dispensing controls, and operates in an efficient and highly precise fashion.

In the description that follows, system 11 is shown in connection with the administration of food to laboratory organisms housed in rack-mounted aquatic tanks. However, it should be noted that system 11 is not limited to use with any particular type of containment device and/or species of laboratory animal. Rather, it is to be understood that system 11 could be utilized in wide variety of applications which require the automated delivery of substances to containment devices without departing from the spirit of the present invention.

As seen in FIG. 1, automated feed system 11 comprises a plurality of multi-tank feeding units 13-1 thru 13-n that operate independently of one another. Accordingly, as a feature of the present invention, it is to be understood that a selection of feeding units 13 may be located either at a common facility (e.g., a single scientific laboratory) or scattered amongst a variety of remote sites.

As will be explained further in detail below, each feeding unit 13 comprises a rack assembly, or support structure, 15 on which is disposed a modifiable arrangement of individual aquatic tanks 17. Additionally, each unit 13 additionally includes (i) a unit controller, or base, 18 fixedly mounted on rack assembly 15 and (ii) a robotic feeder 19 in wireless communication with base 18.

Robotic feeder 19 is adapted to move in three dimensions relative to rack assembly 15 and, in turn, dispense food into tanks 17 in accordance with a programmed feed schedule. Robotic feeder 19 is designed with a number of novel features including, but not limited to, (i) enhanced range of motion, (ii) scan capabilities to monitor the assortment and arrangement of aquatic tanks 17 stored on rack assembly 15, (iii) means of precise registration and alignment with each of the individual tanks in order to dispense food with great efficiency and accuracy, and (iv) wireless communication capabilities to allow for a wider degree of user control. All of the aforementioned features will be explained further in detail in the description that follows.

Base 18 for each feeding unit 13 is configured to communicate with a feed management hub 21 through a designated network communication path (e.g., via the Internet). To facilitate communication with the designated data transmission path, each base 18 is preferably provided with both wireless (WiFi) and ethernet connection capabilities. As will be explained further below, feed management hub 21 is designed to (i) collect and update tank information from each feeding unit 13 (e.g., basic information as well as the exact position of each tank 17 on rack assembly 15), and (ii) maintain, adjust, and apply feed schedules to the multitude of tanks 17 retained by each feeding unit 13.

Feed management hub 21 is represented herein as comprising a central controller 23 for collecting, maintaining, and adjusting tank information as well as the various feed schedules for feed units 13 and, in turn, directly communicating with each base 18, as needed, in order to, inter alia, implement the food distribution schedules. Hub 21 is additionally shown comprising a data storage device 25 in electrical communication with central controller 23 for, among other things, storing feed schedule data or other pertinent information, as required.

Due to the independent communication path established between each feeding unit 13 and feed management hub 21, it is to be understood that feeding units 13 can be located across a wide range of sites. In this capacity, system 11 is rendered highly scalable in that additional feeding units 13 can be readily incorporated into system 11 by simply establishing a communication path between its unit base 18 and feed management hub 21, even if a new feeding unit 13 is situated in a remotely located and/or previously unutilized site.

System 11 is additionally shown comprising at least one user 27 in direct electronic communication with feed management hub 21 using a compute device 29. Preferably, compute device 29 is configured to communicate with feed management hub 21 through a designated website and/or software application that is specifically designed to facilitate the principal operations of feed management hub 21. As such, it is to be understood that compute device 29 represents any web-enabled compute device, such as a desktop computer, laptop computer, smartphone, or the like.

In this capacity, via compute device 29, user 27 is able to monitor and regulate the distribution of food amongst a multitude of different, and potentially remotely located, multi-tank feeding units 13. Furthermore, for ease of illustration and simplicity of understanding, a single user 27 is represented in automated feed system 11. However, as a feature of the invention, it is envisioned that a variety of users 27 could be readily integrated into system 11 by simply connecting to central controller 23 using a web-enabled compute device. In this manner, a variety of different users, with potentially varying levels of access and restrictions, are able to monitor, adjust and initiate the implementation of food distribution schedules amongst multiple feeding units 13.

### Multi-Tank Feeding Unit 13

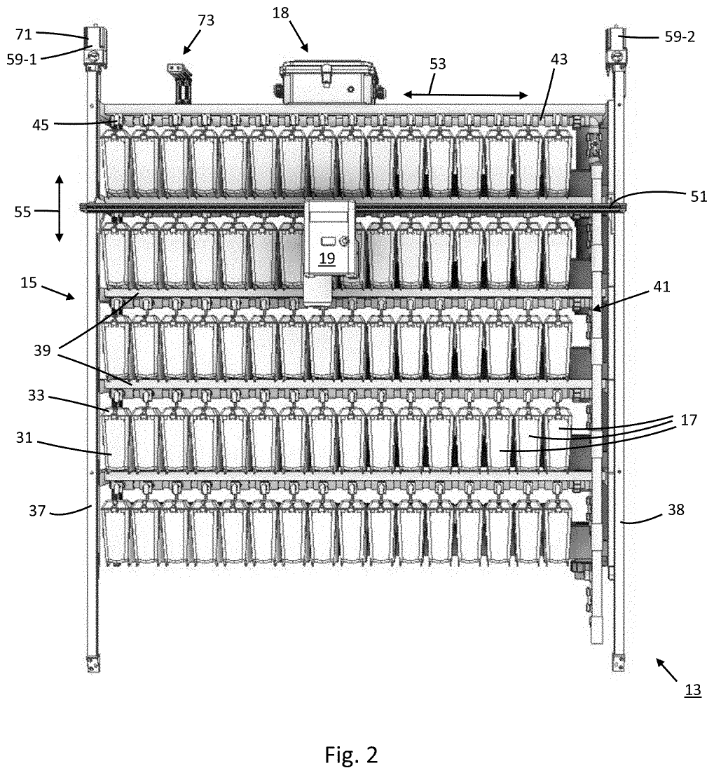

Referring now to FIG. 2, a single multi-tank feeding unit 13 is shown in greater detail. As noted previously, each unit 13 comprises (i) rack assembly 15 designed to support a collection of aquatic tanks 17, (ii) a unit base 18 fixedly mounted on rack assembly 15, and (iii) a robotic feeder 19 in wireless communication with base 18.

Each tank 17 is generally conventional in nature and includes a molded plastic tank body 31 on which is mounted a molded plastic lid, or cover, 33. Together, body 31 and lid 33 define an enclosed interior cavity which is appropriately dimensioned to house a supply of aquatic organisms. The particular size (i.e., volume) of tank body 31 may be varied to accommodate different types of organisms. In addition, lid 33 may be color coded to help visually identify, inter alia, (i) the organism type, (ii) the food type to be dispensed to the organisms retained therein, and/or (iii) the volume associated with each tank 17.

A unique identification code, such as a barcode, may be provided on the front of tank body 31. Accordingly, using optical recognition technology, tank information can be automatically captured and thereby utilized to (i) identify the location of a specific tank 17 within rack assembly 15, and (ii) obtain information regarding the tank, such as the type of organism retained therein, as will be explained further below.

However, as will be explained in detail below, tank information is preferably electronically captured and maintained through optical detection of the edge, or side, of each tank 17 as well as information input by the user. In this manner, any size, shape, or brand of aquatic tank can be utilized within each feeding unit 13, which is highly desirable.

Rack assembly 15 preferably comprises a floor-mountable vertical rack, or frame, 37 that is constructed of a rigid and durable material, such as metal. As shown herein, rack 37 comprises a plurality of vertical columns, or pillars, 38 to which a plurality of open horizontal shelves 39 are fixedly coupled. As can be seen, shelves 39 are appropriately spaced and dimensioned to serve as a surface on which aquatic tanks 17 can be mounted in a side-by-side relationship.

Although described in limited detail herein, rack assembly 15 also preferably includes a water treatment unit 41 that is fixedly connected to rack 37. Water treatment unit 41 includes a network of interconnected pipes, or conduits, 43 in fluid communication with a common water treatment device (not shown). A plurality of spouts 45 is connected to pipes 43, with one spout 45 preferably disposed directly above an inlet port formed in each tank lid 35. In this manner, water treatment unit 41 is able to condition the water retained in each tank 17. Examples of possible water treatment processes that can be implemented via water treatment unit 41 include, but are not limited to, water exchange, debris removal, thermal regulation, ultraviolet disinfection, and pressure regulation.

As a principal feature of the present invention, rack assembly 15 comprises a single horizontal crossbar 51 that supports robotic feeder 19 and, in turn, facilitates displacement of feeder 19 in both the X-dimension, as represented by arrow 53, and the Y-dimension, as represented by arrow 55. As will be explained further below, feeder 19 is additionally capable of translation in the Z-direction, thereby ensuring a highly precise dispensing process. Horizontal crossbar 51 is supported by frame 37 through a pair of vertical drive shafts 59-1 and 59-2.

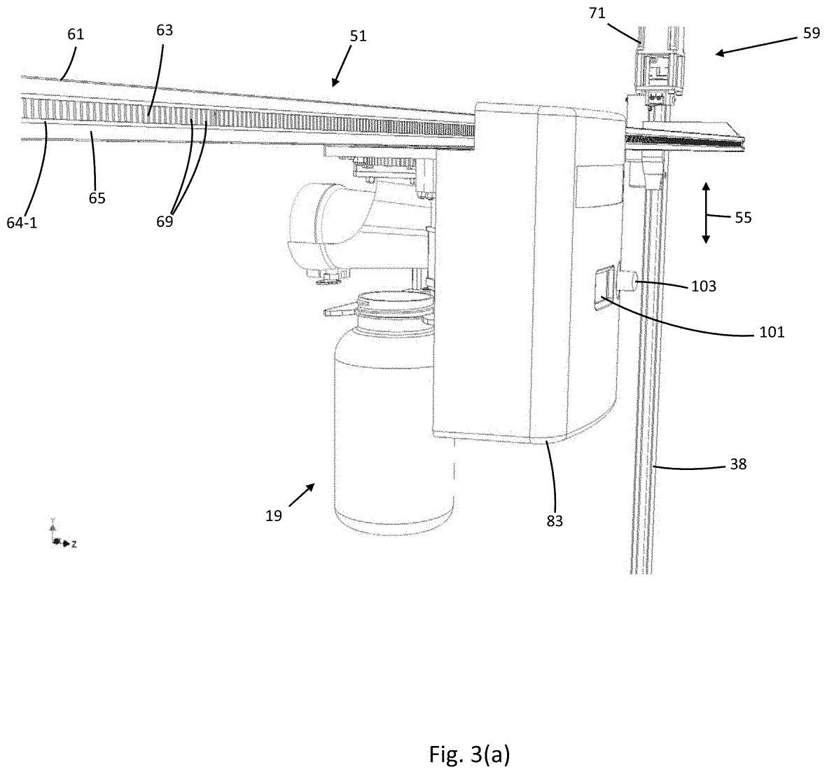

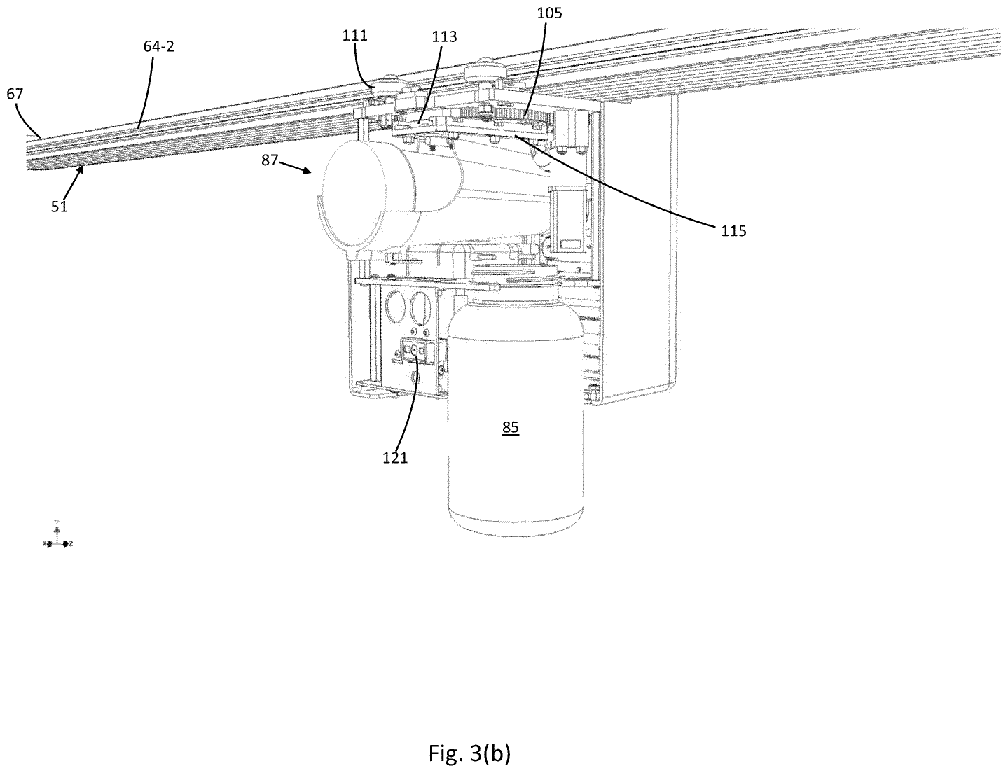

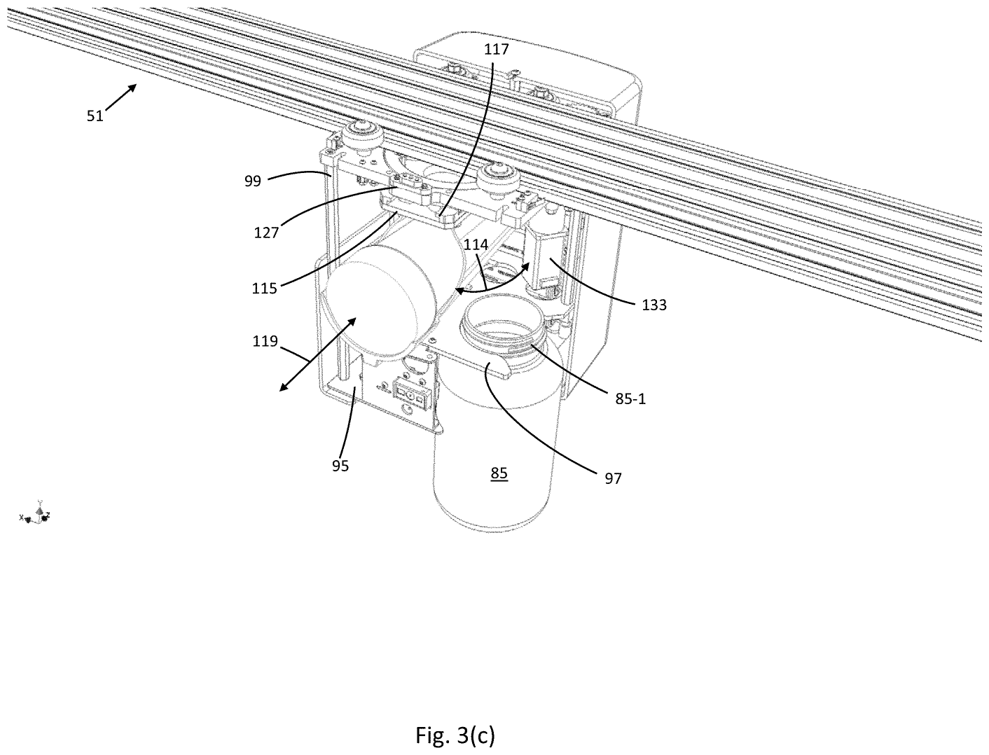

As seen most clearly in FIGS. 3(a)-(c), horizontal crossbar 51 comprises an elongated, linear rail 61 to which is removably coupled a rack-shaped insert, or rack, 63. Preferably, linear rail 61 is formed from three separate, 2020-type, aluminum extrusion rails that are joined together in a side-by-side relationship to collectively define a longitudinal groove 64-1 in its front surface 65 and a longitudinal groove 64-2 in its rear surface 67.

Rack 63 is preferably molded as a unitary plastic piece which includes a plurality of outward protrusions, or teeth, 69 in its front surface, each tooth being generally trapezoidal in transverse cross-section. Rack 63 is designed to be slid into front groove 64-1 through one end of rail 61 and retained therein by opposing flanges integrally formed in rail 61. Because rack 63 is constructed separately from rail 61, it should be noted that rack 63 can be utilized with a number of different rail types in a wide variety of potential applications. Additionally, the separability of rack 63 from rail 61 allows for the potential replacement of rack 63 if teeth 69 wear down or otherwise become damaged over time.

Each drive shaft 59 includes a motor 71 which is fixedly connected to the top of a vertical column 38 on each side of frame 37. A threaded lead screw (not shown) is rotatably driven by each motor 71 and extends through a bore, or bearing, formed in each end of crossbar 51 in threaded engagement therewith. Accordingly, the synchronized rotation of the lead screws for drive shafts 59 causes crossbar 51 to travel vertically along Y-axis 55, with the direction of vertical displacement dependent upon the direction of angular rotation. In this manner, robotic feeder 19 can be vertically positioned at the appropriate height relative to any of shelves 39.

Referring back to FIG. 2, rack assembly 15 also includes a fixed charging station 73 that is mounted on the top of frame 37. As will be explained further below, robotic feeder 19 is designed to periodically connect to charging station 73 in order to recharge a power supply housed within feeder 19. As such, feeder 19 is designed to operate without the physical encumbrance of an elongated electrical tether.

### Robotic Feeder 19

As noted above, the unique construction and various operational capabilities of robotic feeder 19 serve as primary novel features of the present invention. Referring now to FIGS. 3(a)-3(c), 4 and 5, robotic feeder 19 is a self-contained and compact unit that comprises (i) a printed circuit board assembly 81 with various electrical and mechanical components which together implement the principal operations of feeder 19, (ii) a cover, or shroud, 83 for partially enclosing, and thereby protecting, sensitive components of printed circuit board assembly 81, (iii) a liquid food canister 85 retained by printed circuit board assembly 81 for holding a supply of liquid food to be distributed by feeder 19, and (iv) a dry food dispenser 87 retained by printed circuit board assembly 81 for supplying, metering, and dispensing solid food to be distributed by feeder 19.

Printed circuit board assembly 81 comprises a main printed circuit board (PCB) 91 to which are coupled a top plate 93, a bottom plate 95, and an intermediate plate 97. Plates 93, 95, and 97 are horizontally arranged in a spaced apart relationship and are fixedly joined by a plurality of vertical reinforcement spacers 99 to provide PCB assembly 81 with adequate structural integrity.

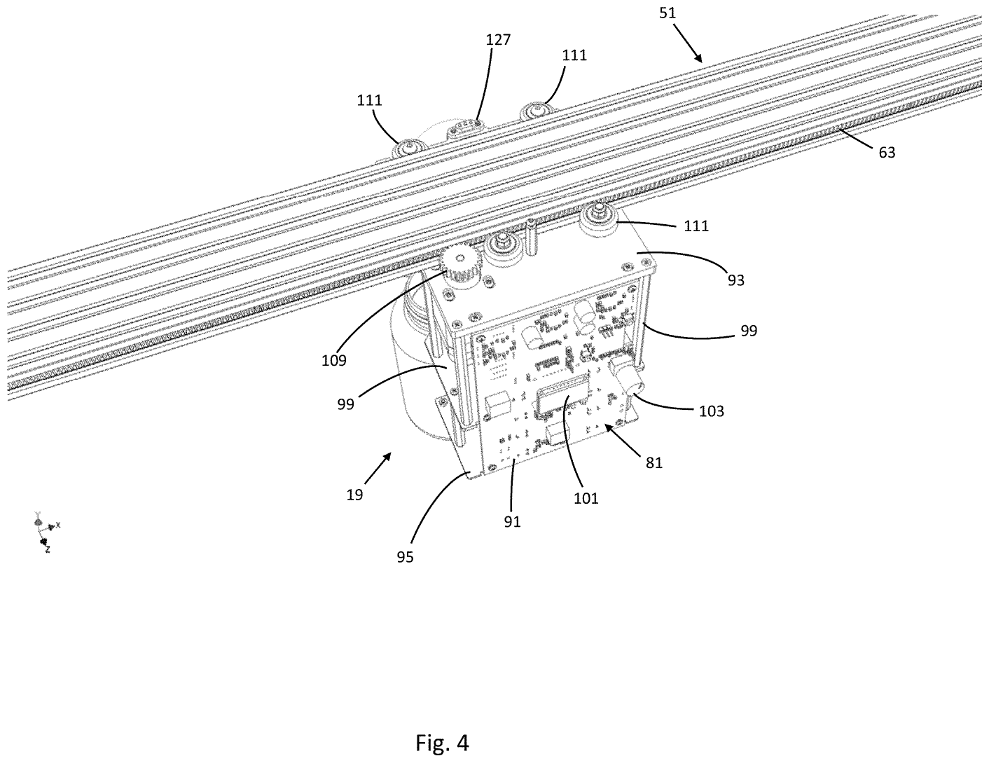

Main PCB 91 includes the principal processing devices that enable robotic feeder 19 to communicate with base 18 and, in turn, feed management hub 21. As such, robotic feeder 19 is configured to receive and implement the principal food dispensing operations in accordance with user-defined feed schedules. As seen most clearly in FIGS. 3(a) and 4, main PCB 91 includes (i) a digital display screen 101 for providing visual information relating to the operational status of feeder 19 and (ii) a rotary knob 103 for providing certain manual controls for feeder 19.

Referring back to FIGS. 3(a)-3(c), 4 and 5, PCB assembly 81 additionally includes a gear assembly 105 that is selectively driven by a motor 107. As will be explained further below, gear assembly 105 and motor 107 together allow for movement of selected components of robotic feeder 19 in both the X-direction and the Z-direction.

A drive wheel 109 and a plurality of passive guide rollers 111 are rotatably mounted on top plate 93. Guide rollers 111 are positioned so to align within front groove, or channel, 64-1 and rear groove, or channel, 64-2 in linear rail 61. In this capacity, rollers 111 maintain robotic feeder 19 coupled to rail 61 and restrict movement along X-axis 53.

Drive wheel 109 is positioned within front channel 64-1 and is shaped to engage teeth 69 in rack 63. Additionally, drive wheel 109 is connected to motor 107 via gear assembly 105. Accordingly, drive wheel 109 is designed to be rotatably driven by motor 107 and thereby move robotic feeder 19 longitudinally along rail 61. As a result, robotic feeder 19 is capable of being positioned directly above each aquatic tank 17 on rack 37.

A T-shaped protrusion, or head, 113 protrudes downwardly from top plate 93 and is rotatably coupled thereto, as seen most clearly in FIGS. 3(b) and 3(c). Head 113 is adapted to rotate 90 degrees, as represented by arrow 114 in FIG. 3(c), between a first position in which the longitudinal axis of head 113 lies orthogonal to the longitudinal axis of rail 61 and a second position in which the longitudinal axis of head 113 lies parallel to the longitudinal axis of rail 61. In this manner, components of robotic feeder 19 can be pivoted to a nested, or protected, position, when feeder 19 moves relative to frame 37.

Additionally, a U-shaped carriage, or bracket, 115 is slidably mounted on head 113 and includes a pair of opposing pins, or fingers, 117 that extend partially inward to retain carriage 115 mounted onto head 113. Carriage 115 is connected to motor 107 via gear assembly 105. Accordingly, carriage 115 is designed to be linearly displaced relative to head 111 in the Z-direction, as represented by arrow 119 in FIG. 3(c). As can be appreciated, the ability to move the critical dispensing components of automated feeder 19 in three dimensions ensures that food is distributed to each of the plurality of tanks 17 with great precision (i.e., without spillage), which is highly desirable.

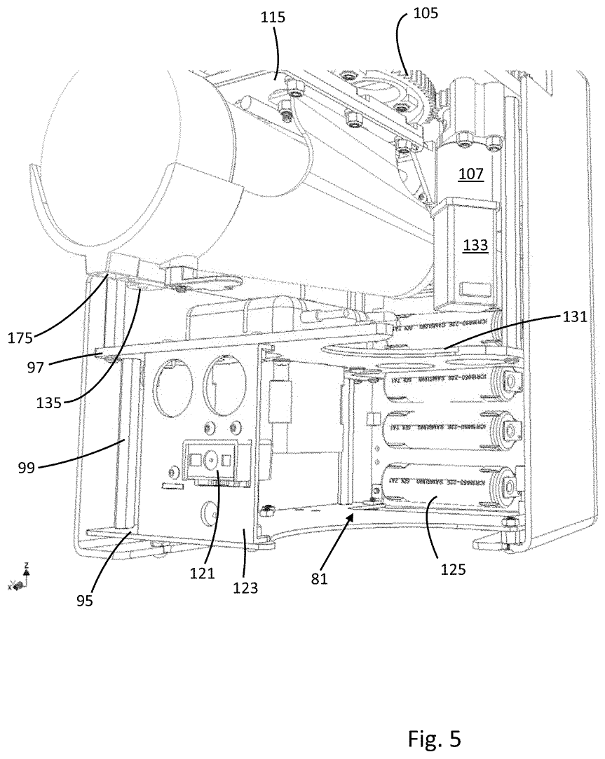

PCB assembly 81 additionally includes a laser sensor 121 that is mounted on a bracket 123 which extends between bottom plate 95 and intermediate plate 97, as seen most clearly in FIG. 5. Sensor 121 is electrically connected to main PCB 91 and serves to, inter alia, (i) scan any unique optical identifiers provided on individual tanks 17 (i.e., to help collect and maintain useful information relating to each tank 17), and (ii) assist in the registration, or alignment, of robotic feeder 19 relative to each tank 17 by locating each tank sidewall, or edge.

PCB assembly 81 further includes a power supply 125, represented herein as a set of rechargeable batteries, in electrical connection with main PCB 91. As can be appreciated, power supply 125 provides the various electrical components of robotic feeder 19 with the requisite electrical power. Power supply 125 is electrically coupled to a three-terminal connector 127 mounted on top plate 93, as seen most clearly in FIG. 4. As will be explained further below, robotic feeder 19 is designed to periodically travel such that connector 127 is drawn into direct electrical contact with charging station 73. As a result, robotic feeder 19 is able to maintain the necessary power to communicate with unit base 18 and thereby perform the primary food dispensing operations.

As seen most clearly in FIGS. 3(c) and 5, intermediate plate 97 is shaped to define a semi-circular cutout 131 which is dimensioned to engage the threaded neck 85-1 of liquid food canister 85. In this manner, liquid food canister 85 is capable of being suspended from plate 97 in a vertical orientation. A first length of tubing (not shown) extends from the interior of canister 85 to a pump 133 in electrical connection with main PCB 91. As second length of tubing (not shown) extends from pump 133 and into fitted insertion within a liquid outlet port 135 in dry food dispenser 87. Accordingly, pump 133 is designed to draw a fixed amount of liquid food from canister 85 and, in turn, deliver the liquid to a particular tank 17 using the second length of tubing.

Dry food dispenser 87 is fixedly mounted onto the underside of carriage 115 and, as referenced above, retains the free end of the second length of tubing in fluid communication with liquid food canister 85. By virtue of its coupling to carriage 115, dry food dispenser 87 and the liquid food delivery tube connected thereto are both capable of moving in the Z-direction along axis 119 as well as being rotated 90 degrees about the Y-axis. As such, dry food dispenser 87 is capable of being selectively positioned directly over a food inlet formed in cover 33 of each aquatic tank 17, thereby minimizing the risk of any spillage of liquid or dry food.

### Dry Food Dispenser 87

Dry food dispenser 87 is uniquely designed to meter and dispense a precise amount of dry food. As will be described in detail below, components of dispenser 87 are designed to spin, or turn, about its longitudinal axis to accurately apportion and deliver a fixed amount of food.

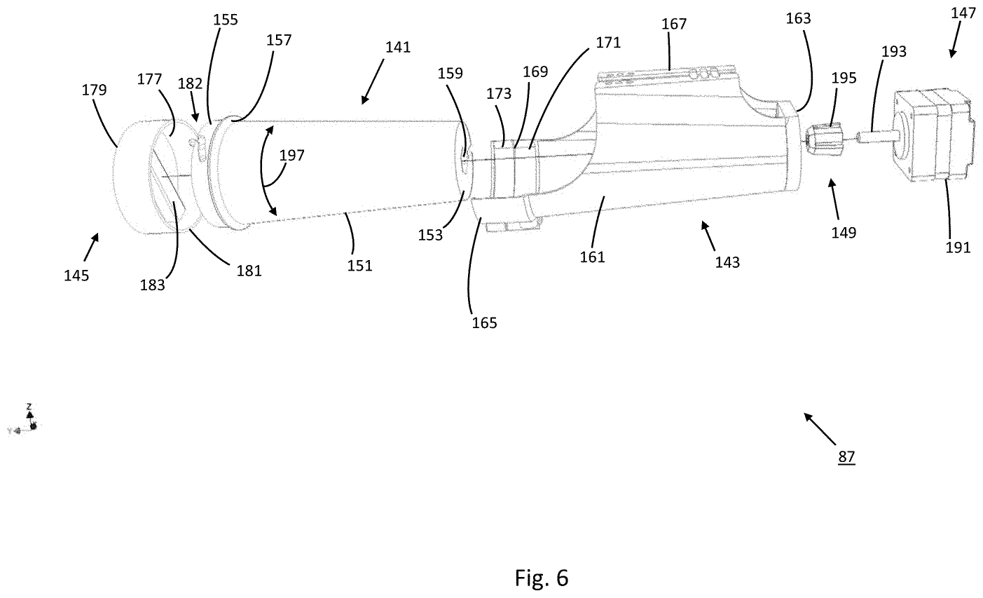

Specifically, referring now to FIG. 6, dry food dispenser 87 is shown in isolation. As can be seen, dry food dispenser 87 comprises (i) an enlarged, dry food canister 141, (ii) a support bracket 143 adapted to hold canister 141, (iii) a metering cap 145 removably coupled to canister 141, (iv) a rotary motor 147 for selectively rotating canister 141 about its longitudinal axis, and (v) a coupler 149 for connecting canister 151 to motor 147.

Canister 141 is constructed as a unitary, cup-shaped member which includes a continuous frustoconical sidewall 151, a narrow, enclosed bottom end 153, and a widened, open top end 155 which together define an interior cavity dimensioned to receive a supply of dry food, such as food pellets. An outwardly projecting flange 157 is integrally formed on sidewall 151 proximate top end 155 and helps retain canister in place on support bracket 143. Additionally, a cavity 159 is formed in closed bottom end 153 and is dimensioned to receive coupler 149, as will be explained further below.

Support bracket 143 is constructed as a unitary member which includes a generally U-shaped sidewall 161, a partially enclosed, plate-shaped, bottom end 163, and an open front end 165. Sidewall 161 is shaped to include a pair of opposing top tabs 167 which are fixedly secured to the underside of carriage 115 by fasteners (not shown). In this manner, any movement of carriage 115 serves to similarly displace support bracket 143.

Open front end 165 of bracket 143 is in the shape of a 180-degree arcuate collar. An upwardly projecting partition, or wall, 169 serves to separate front end, or collar, 165 into a liquid food delivery section 171 and a dry food delivery section 173. Section 171 is adapted to receive tubing in communication from canister 85 and, in turn, deliver liquid food out through port 135. Section 173 is shaped to define a thru-hole, or outlet, 175 through which solid food is delivered, with outlet 175 visible in FIG. 5.

Metering cap 145 is designed not only to selectively enclose open top end 155 of canister 141 but also to measure, or dose, a fixed quantity of solid food through rotation of canister 141. Cap 145 comprises an annular sidewall 177, a closed front end 179 and an open rear end 181. Cap 145 is dimensioned to be removably mounted over open top end 155 with rear end 181 in direct abutment against flange 157.

A pin and slot-type locking interface 182 is preferably provided onto metering cap 145 and top end 155 of canister 141, respectively. Accordingly, through rotation of cap 145 relative to canister 141, interface 182 serves to releasably secure cap 145 in position over top end 155 of canister 141.

A transverse funnel, or trough, 183 is integrally formed onto the interior of closed front end 179. Funnel 183 is shaped to include an inlet (not shown) in communication with the interior of canister 141. Additionally, an outlet (not shown) is formed in sidewall 177 in alignment with trough 183. As will be explained further below, cap 145 is designed such that a fixed dose of solid food collects in funnel 183 as canister 141 rotates. In this manner, cap 145 helps distribute a reliable and consistent dose of solid food from canister 141, which is an object of the present invention.

Rotary motor 147 is designed to selectively rotate canister 141 about its longitudinal axis. Motor 147 is represented herein as comprising a base, or housing, 191 from which protrudes an axle 193. Base 191 is fixedly mounted onto the exterior surface of bottom end 163 and houses electronics in electrical communication with PCB assembly 81.

Activation of motor 147 results in the rotation of axle 193. Coupler 149 is axially mounted over the free end of axle 193 and is designed to press fit into cavity 159 in canister 141. Coupler, or insert fastener, 149 includes a pair of articulating fingers, or wings, 195. Fingers 195 are designed to flex inward as coupler 149 is press fit into cavity 159. Upon reaching a cutout, or notch, with cavity 159, wings 195 expand resiliently outward, creating a secure means of connection between motor 147 and canister 141. As such, activation of motor 147 serves to rotate canister 141 about its longitudinal axis, as represented by arrows 197 in FIG. 6.

Through the temporary inward articulation of wings 195, cannister 151 can be separated from coupler 149. In this manner, cannister 141 can be easily replenished with a supply of dry food, as needed. Coupler 149 also serves to smooth out the rotation of cannister 151 by minimizing the effects of any recoil experienced by motor 147.

As can be appreciated, dry food dispenser 87 is designed to operate in the following manner. Specifically, activation of motor 147 causes canister 141 to rotate about its longitudinal axis, as represented by arrow 197. With flange 157 of canister 141 in abutment against partition 169, cannister 141 remains properly positioned on fixed bracket 143 as cannister 141 rotates.

As referenced above, rotation of canister 141 causes a supply of dry food to enter into and fill hollowed trough 183. Continued rotation of canister 141 ensures that a full dose of dry food is effectively trapped within the entire length of trough 183. Upon completion of a single rotation, the hole in cap sidewall 181 is oriented downward in direct alignment with outlet 175 in support bracket 143. In this manner, the metered dose of dry food exits trough 183, passes through outlet 174 in support bracket, and enters into the intended tank 17 through the food inlet in tank lid 33.

### Operation of Robotic Feeder 19

As referenced above, robotic feeder 19 is designed to (i) routinely perform scanning operations to monitor, or track, the presence and relative location of tanks 17 on rack 37 and (ii) dispense a specific amount and type of food to a user-defined selection of tanks 17 in accordance with a modifiable feed schedule. The ability to automatically monitor aquatic tanks 17 and, in turn, distribute food to organisms retained therein is critical to sustaining the aquatic animals in a suitable environment.

As referenced above, unit base 18 serves as a communication link between its associated robotic feeder 19 and feed management hub 21. By utilizing unit base 18 to communicate with feed management hub 21 (e.g., to transmit tank information and receive tank feed schedules), the power and data transmission requirements of robotic feeder 19 can be minimized. As a result, robotic feeder 19 can rely upon wireless power and data transmission, thereby eliminating the need for electrical tethers or communication cables that may otherwise serve as physical encumbrances.

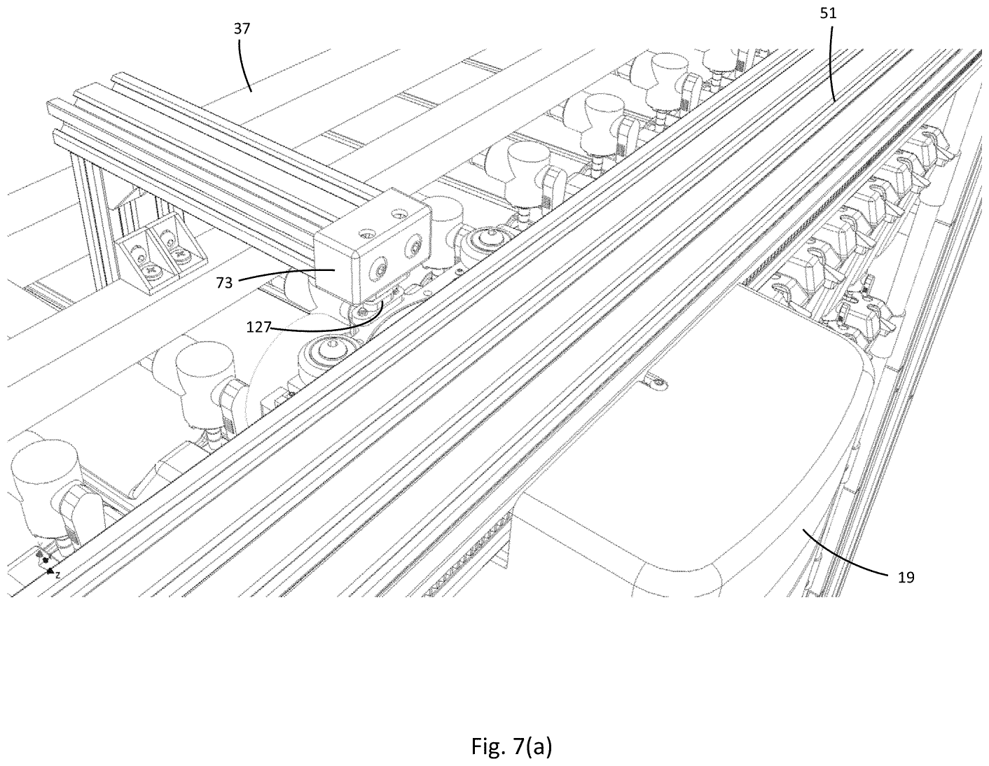

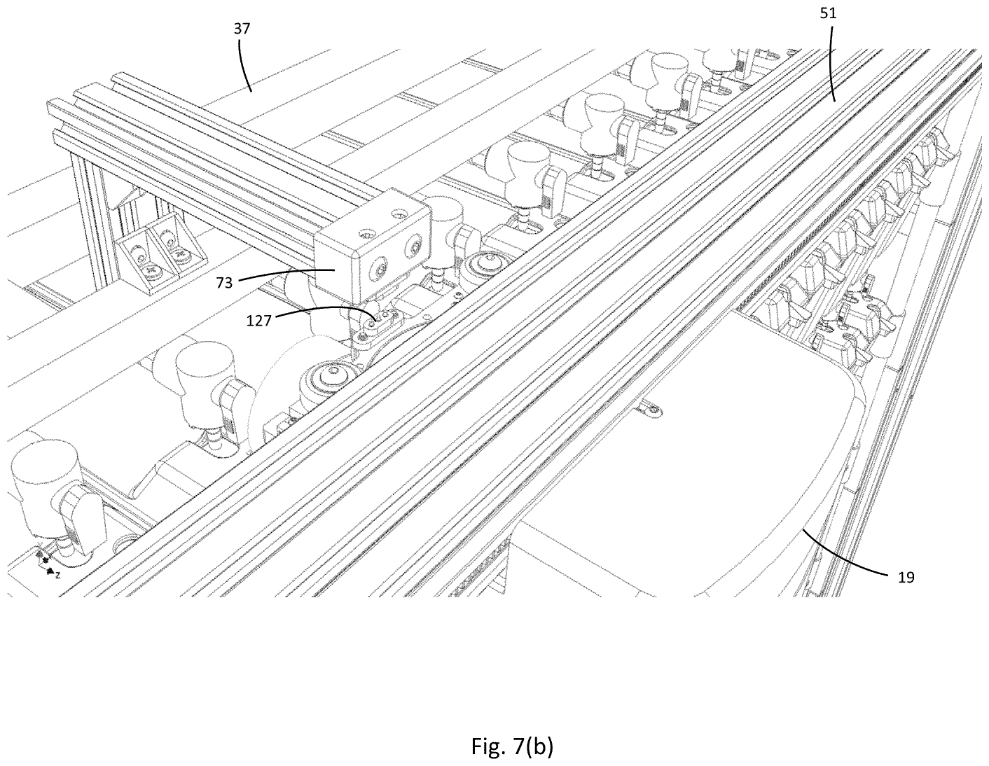

When not in use, wireless robotic feeder 19 is preferably docked, or connected, to fixed charging station 73. As seen most clearly in FIG. 7(a), crossbar 51 is adjusted vertically and robotic feeder 19 is displaced laterally along crossbar 51 until connector 127 on feeder 19 electrically contacts charging station 73. As such, feeder power supply 125 maintains an adequate charge to perform routine tasks. When instructed to operate, crossbar 51 moves vertically downward until connector 127 separates from charging station 73, as shown in FIG. 7(b), thereby freeing robotic feeder 19 to move relative to frame 37.

As a feature of the present invention, robotic feeder 19 is designed to scan each shelf 39 of rack 37 in order to monitor the presence and specific location of each aquatic tank 17. Because tanks 17 are frequently added, removed and/or repositioned on rack 37 during routine use in a laboratory, the ability to track the precise arrangement of tanks 17 on rack 37 is critical to ensure proper feeding is maintained. Scanning is accomplished by moving robotic feeder 19 downward in the Y-direction 55 to each successive shelf 39 and, in turn, displacing feeder 19 laterally in the X-direction 53 across the width of frame 37.

Laser sensor 121 is designed to optically scan the sidewalls of each aquatic tank 17 to identify its presence and precise location on rack 37. More specifically, by scanning the sidewalls of each tank 17, feeder 19 is capable of automatically determining the type and size of aquatic tank 17, provided that basic tank information is initially input by the user through a tank configuration step to be explained in detail below.

Additionally, each tank 17 may include a label on its front surface that is provided with a unique identifier to assist in the compilation and maintenance of tank-specific data. Although optical recognition is referenced herein, it should be noted that alternative techniques of automated data capture (e.g., radio frequency identification (RFID)) could be used in place thereof without departing from the spirit of the present invention.

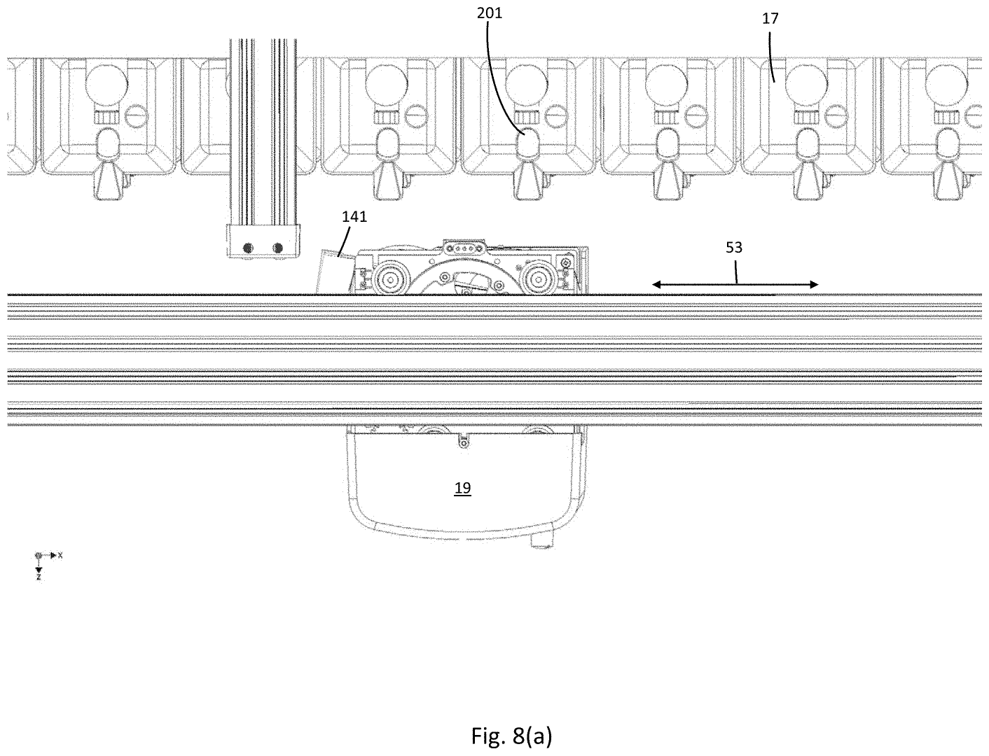

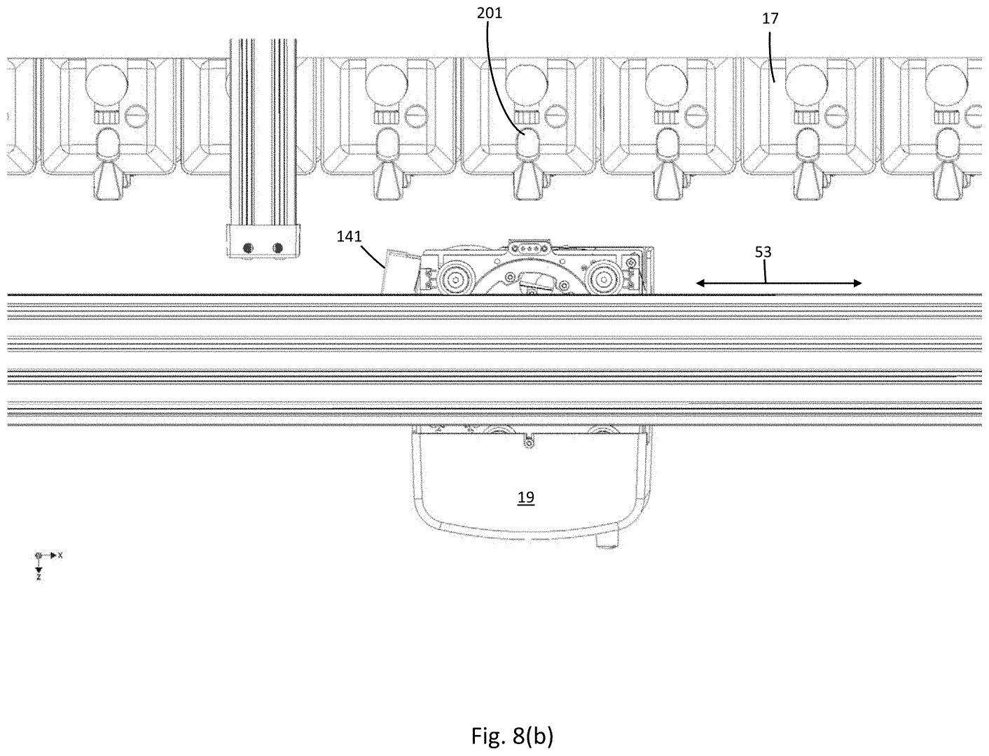

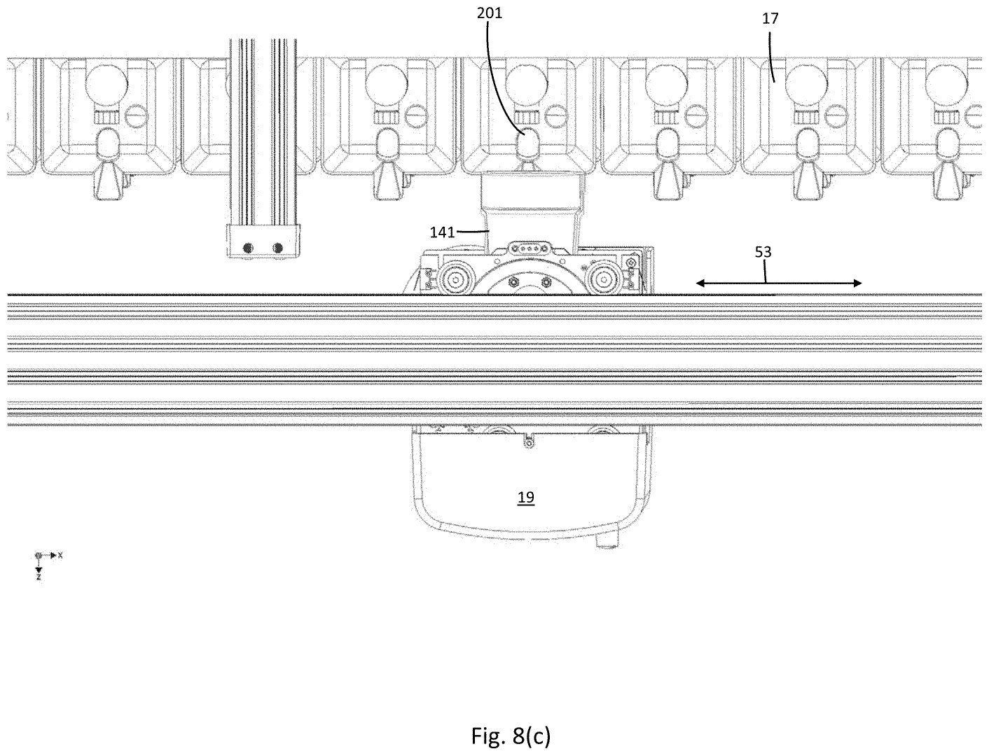

To dispense food in accordance with a programmed feed schedule, robotic feeder 19 wirelessly receives the specific feed commands transmitted to unit controller 18 from feed management hub 21. Robotic feeder 19 then initiates the food dispensing process by activating drive shafts 59 such that horizontal crossbar 51 and, in turn, robotic feeder 19 are vertically disposed at the appropriate shelf 39. It should be noted that motor 107, gear assembly 81, and carriage 115 together rotate and maintain dry food dispenser 87 such that the longitudinal axis of cannister 141 extends generally parallel to X-axis 53, as shown in FIG. 8(a). Disposed as such, cannister 141 is protected from any inadvertent, and potentially damaging, contact with aquatic tanks 17 that are improperly mounted on rack 37.

Robotic feeder 19 then activates drive wheel 109 so as to engage rack 63 and, in turn, displace feeder 19 along rail 61 in X-direction 53. Once optical sensor 121 detects the edge of a particular tank 17, as shown in FIG. 8(a), feeder 19 translates laterally until directly aligned with its center, as shown in FIG. 8(b). As previously noted, feeder 19 is able to precisely align with the center of a tank 17 upon locating one of its sidewalls by using tank dimension information stored for each type of tank 17. Thereafter, cannister 141 is rotated 90 degrees and into direct alignment over the desired tank 17, as shown in FIG. 8(c).

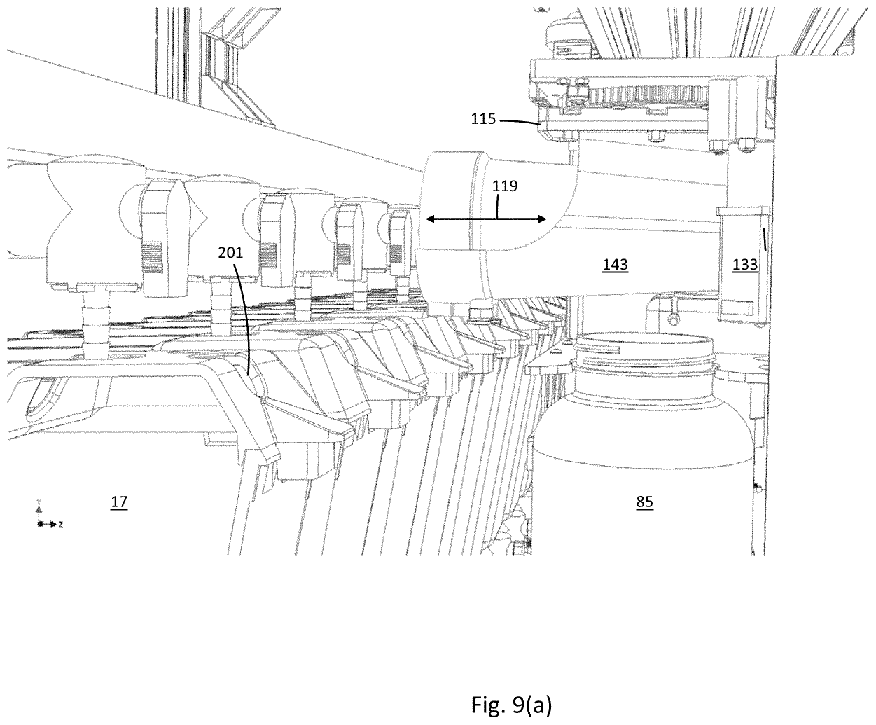

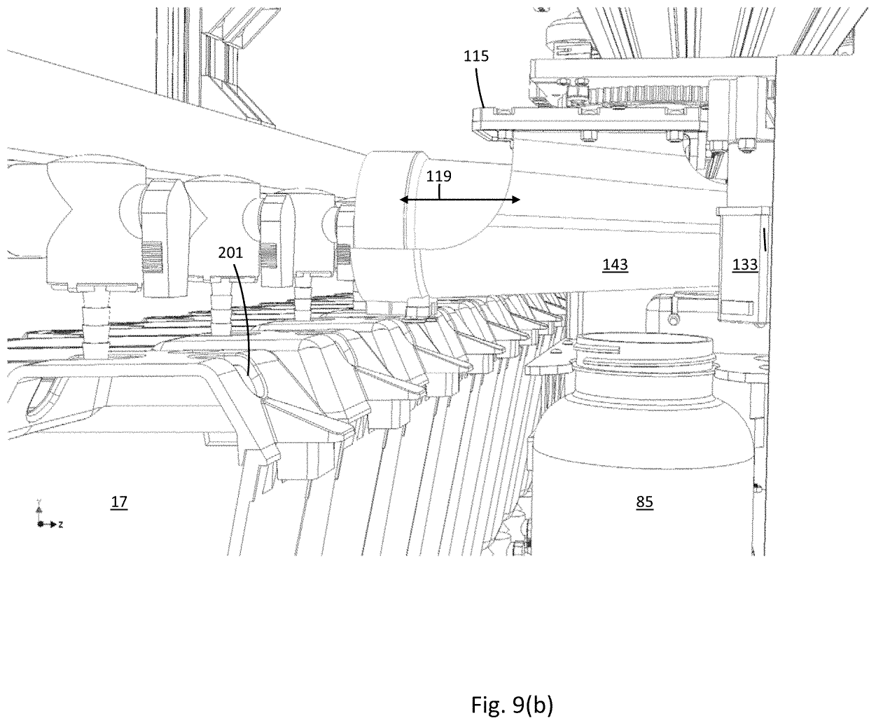

In order to dispense liquid food, carriage 115 is displaced along Z-axis 119 so as to move cannister holder 143 from a retracted position, as shown in FIG. 9(a), to an extended position, as shown in FIG. 9(b). As can be appreciated, holder 143 is preferably extended such that liquid outlet port 135 is disposed directly above a food inlet port 201 formed in the desired tank 17. Once again, precise alignment is achieved, in part, by storing the exact tank dimensions.

With carriage 115 properly positioned, liquid food can then be drawn and delivered by pump 133 to the desired tank 17 with a high degree of accuracy. Preferably, pump 133 applies reverse suction onto the delivery tube upon completion of the dispensing process to prevent any unintentional drippage from occurring thereafter.

In order to dispense solid food, carriage 115 is similarly displaced along Z-axis 119 so as to move cannister holder 143 from a retracted position, as shown in FIG. 9(a), to an extended position, as shown in FIG. 9(b). Preferably, holder 143 is extended such that solid food outlet 175 is disposed directly above food inlet port 201 in the desired tank 17. Thereafter, canister 141 is rotatably driven by motor 145 so that a properly metered dosage of dry food collects within hollowed trough 183. Once canister 141 completes a single, 360-degree, rotation, the hole in cap sidewall 181 directly aligns with outlet 175 in support bracket 143 and the metered dose of dry food exits cap 145 and enters into tank 17 through food inlet port 201.

### User Interface

As noted previously above, system 11 is implemented with a software platform that enables each user 27 to interface with feed management hub 21. Therefore, through a series user-intuitive graphical displays, each user 27 is capable of monitoring the status of multiple feeding units 13 and implementing an appropriate feed schedule.

It should be noted that varying levels of access and controls may be designed for different users 27. For instance, the ability to modify the feed schedule for a particular unit 13 may be restricted to supervisory personnel, with all other users 27 limited to monitoring the real-time operational status (e.g., to ensure feed efficacy).

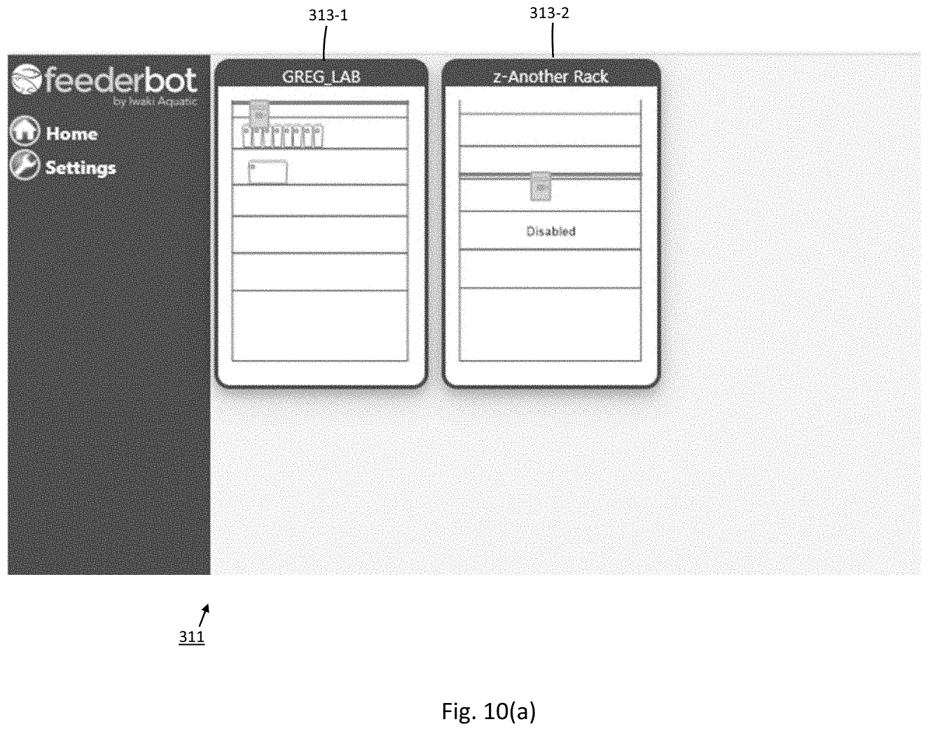

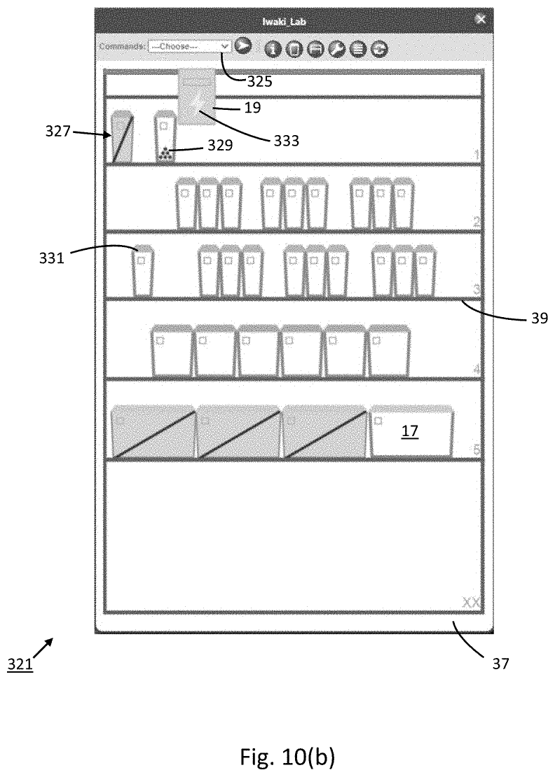

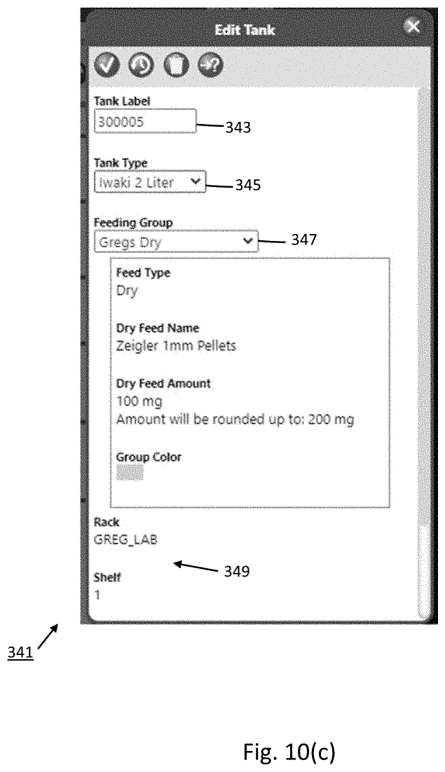

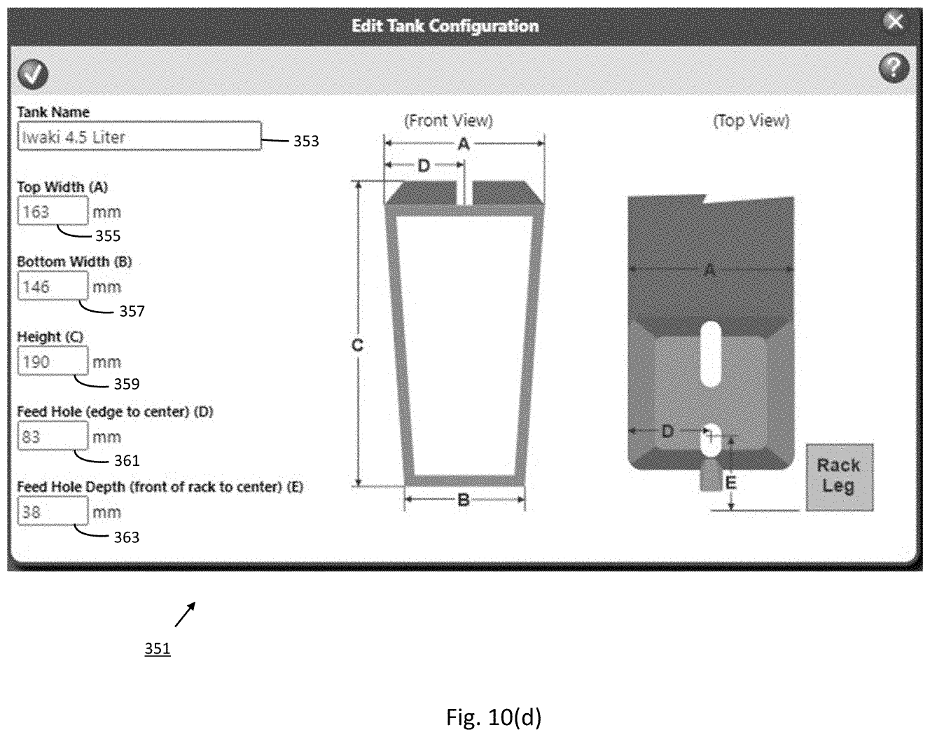

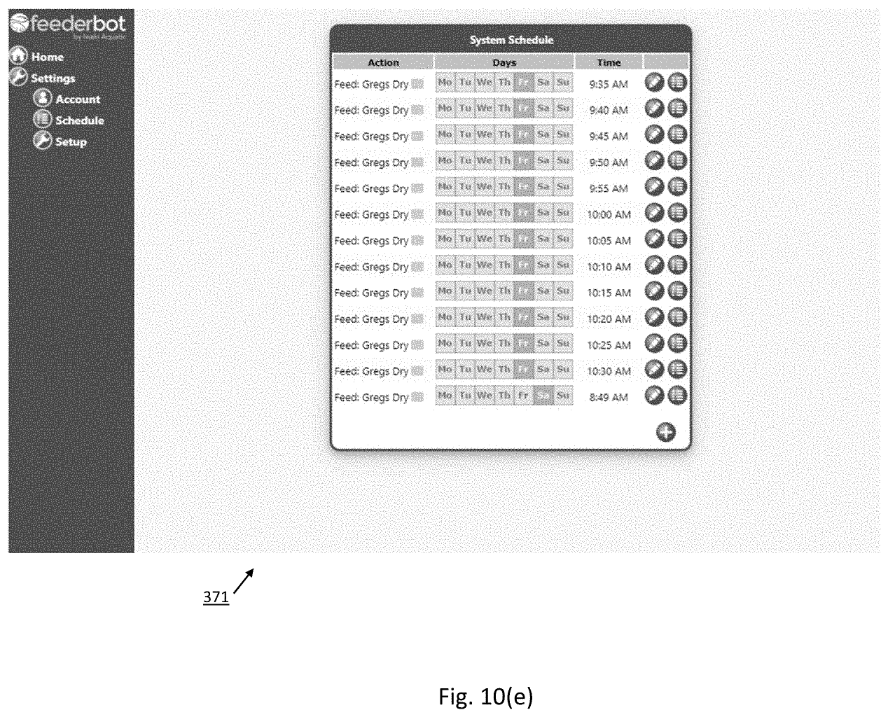

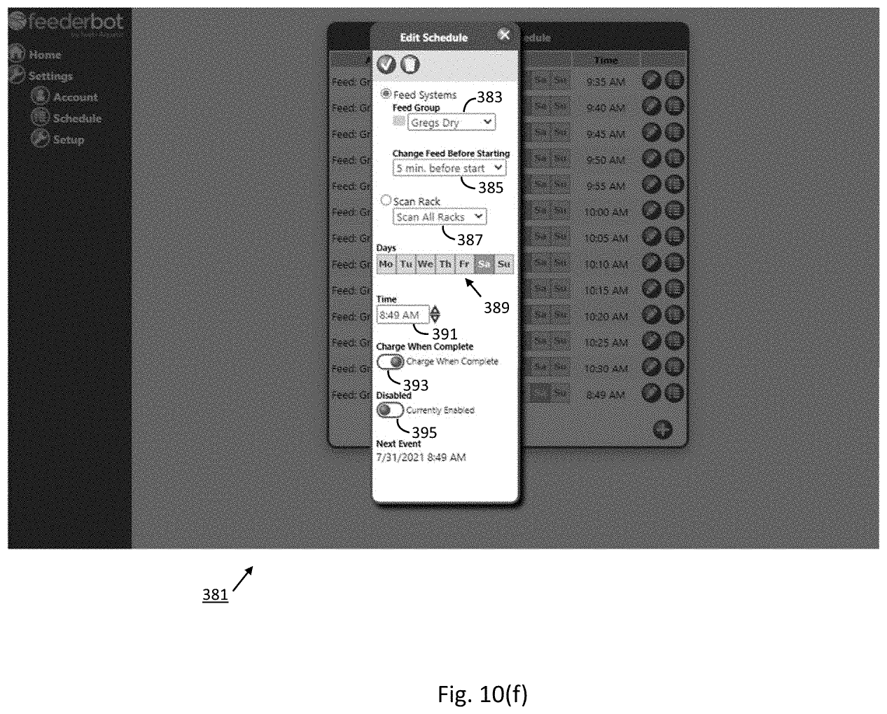

Referring now to FIGS. 10(a)-(f), there are shown a series of sample screen displays for the software platform which together illustrate how users 27 can monitor and control multiple individual feeding units 13 whether located at a common facility or dispersed across numerous remote sites. Preferably, each user 27 accesses the software platform with a compute device 29 through a designated website and/or downloadable software application. Upon launching the software and completing the user sign in process, user compute device 29 is directed to a home screen 311, as shown in FIG. 10(a). On home screen 311, the individual feeding units 13 available for monitoring by user 27 are represented as simplified rack renderings 313-1 and 313-2. As can be seen, each rendering 313 visually depicts the name and operational status of its associated unit 13 as well as provides a simplified overview of the current number and arrangement of tanks 17 on each rack assembly 15.

By clicking on one of renderings 313, a more detailed depiction of the selected feeding unit 13 is displayed in a feeding unit pop-up window 321, as shown in FIG. 10(b). Window 321 depicts, inter alia, (i) the individual shelves 39 of its rack 37, (ii) the arrangement of aquatic tanks 17 on each shelf 39 of rack 37, and (iii) the real-time location of its robotic feeder 19.

Window 321 additionally includes a drop-down window 325 which supports a number of commands, or controls, that can be applied to its associated unit 13 including, but not limited to, (i) performing a tank scan to update the location and arrangement of tanks 17 on shelves 39, (ii) editing information associated with a particular tank 17, and (iii) examining the current feed schedule designated for unit 13.

As features of the present invention, window 321 is configured to depict (i) disabled tanks with a disabled tank icon 327 so that user 27 can intuitively identify which tanks have been designated to, at least temporarily, not receive food from feeder 19, (ii) a supply of food 329 in selected tanks 17 which slowly diminishes over time to intuitively indicate the approximate real-time amount of food remaining in each tank 17, (iii) color-coded tank lids 331 to intuitively indicate the amount and/or type of feed its associated tank 17 is designated to receive, (iv) a charging icon 333 on feeder 19 when docked for recharging, icon 333 appearing as yellow when actively charging and green once fully charged, and (v) an error icon (not shown) displayed over a tank 17 if there is detected a problem in administering food to that tank.

As seen in FIG. 10(c), selecting a particular tank 17 for detailed review and, if necessary, modification yields a tank editing screen 341, as shown in FIG. 10(c). As can be seen, screen 341 is designed to provide basic information pertaining to the selected tank 17 which includes (i) a tank label window 343 that lists the unique identification code (e.g., a barcode) applied to the front of its tank body, (ii) a tank type drop-down window 345 that selects the manufacturer and size of the selected tank 17 from a predefined list, (iii) a feeding group drop-down window 347 that selects, from a predefined list, to which feeding group the selected tank 17 is assigned (i.e., the cluster of tanks to receive the same food type at a particular time), and (iv) its current location information 349 (i.e., rack name and shelf).

If tank drop-down window 345 does not list the proper manufacturer and size of the selected tank 17 from the predefined list, user 27 is able to input new or corrected tank data to be maintained by feed management hub 21. Specifically, by selecting the appropriate command from screen 341, a tank configuration screen 351 is displayed to user 29, as shown in FIG. 10(d). As can be seen, user 29 is able to input detailed information about the selected tank 17 which includes (i) a tank name window 353 for identifying the tank manufacturer and size, (ii) a top width window 355 for inputting the width of the tank cover 35, (iii) a bottom width window 357 for inputting the width of the bottom of tank body 31, (iv) a height window 359 for inputting the height of tank body 31, (v) a feed hole width window 361 for inputting the lateral distance of food port, or hole, 201 relative to the side of tank cover 35, and (vi) a feed hole depth window 363 for inputting the depth of food port 201 relative to rack columns 38. By collecting the detailed dimensions of each tank 17, the precise registration and dispensing of food can ultimately be achieved.

If user 29 desires to review the current feed schedule applied to unit 13, the appropriate command is selected from drop-down window 325 in pop-up window 321. In response, a comprehensive feed schedule screen 371 is displayed to user 29, as shown in FIG. 10(e). On screen 371, each scheduled feed dispensing process is represented in terms of its feed group (i.e., selection of tanks 17 to receive food) as well as its weekly day and time of programmed execution. In this manner, user 27 can inspect the sufficiency of food scheduled for delivery to each tank 17 in each feeding unit 13 and, if authorized, make any required adjustments.

If a scheduled feed dispensing process requires adjustment, an edit button for each scheduled feed can be selected from screen 371. In turn, a feed schedule pop-up window 381 is enabled, as shown in FIG. 10(f), to enable user 27 to make modifications to the scheduled dispensing process. As can be seen, window 381 includes, among other things, (i) a feed group drop-down window 383 that enables user 27 to modify the feed group to which the feed operation is to be applied, (ii) a change feed drop-down window 385 which allows user 27 to specify the time prior to a scheduled feed operation that an automated warning is to be issued to replace the supply of food maintained by robotic feeder 19, (iii) a scan rack radio button and drop-down window 387 for use in designating preset times to initiate a rack scan (i.e., in lieu of a feeding operation), (iv) a weekly calendar bar 389 for selecting the individual days of the week to implement the feed operation, (v) a time window 391 for selecting the time of day to implement the feed operation, (vi) a first slide button 393 for selecting whether robotic feeder 19 should automatically recharge immediately after completion of the feed operation, and (vii) a second slide button 395 for selecting whether robotic feeder 19 is to be disabled, thereby suspending all future operability until otherwise instructed.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A system for automatically dispensing food into a plurality of aquatic tanks, the system comprising:
(a) a plurality of feeding units, each feeding unit comprising,
(i) a rack assembly adapted to support a set of the plurality of aquatic tanks in a modifiable arrangement,
(ii) a unit controller mounted on the rack assembly, and
(iii) a robotic feeder in wireless communication with the unit controller, the robotic feeder being adapted to move relative to the rack assembly and dispense food into a selection of the set of the plurality of aquatic tanks at specified time intervals in accordance with at least one feed schedule; and
(b) a feed management hub in communication with the unit controller for each of the multi-tank feeding units;
(c) wherein the feed management hub maintains the at least one feed schedule to be implemented by the robotic feeder for each of the plurality of feeding units.

2. The system as claimed in claim 1 wherein the at least one feed schedule maintained by the feed management hub is user accessible and selectively modifiable.

3. The system as claimed in claim 2 wherein the feed management hub compiles tank type and location information relating to the arrangement of the set of the plurality of aquatic tanks on each rack assembly.

4. The system as claimed in claim 3 wherein the robotic feeder comprises a laser sensor for scanning the rack assembly to update the tank type and location information for the modifiable arrangement of the first set of aquatic tanks that is maintained by the feed management hub.

5. The system as claimed in claim 4 wherein the feed management hub is in independent communication with the unit controller for each of the plurality of multi-tank feeding units.

6. The system as claimed in claim 5 wherein the rack assembly comprises:
(a) a frame which includes a plurality of horizontal shelves fixedly coupled to a set of vertical columns;
(b) a pair of vertical drive shafts coupled to the frame, each of the pair of vertical drive shafts having a length; and
(c) a horizontal crossbar mounted on the pair of vertical drive shafts, the horizontal crossbar being designed to travel along at least a portion of the length of the pair of vertical drive shafts;
(d) wherein the robotic feeder is mounted onto the horizontal crossbar and is designed for axial displacement.

7. The system as claimed in claim 6 wherein at least a portion of the robotic feeder is configured to move in three dimensions relative to the frame.

8. The system as claimed in claim 7 wherein the horizontal crossbar comprises an elongated, linear rail to which is removably coupled a rack-shaped insert with a plurality of teeth.

9. The system as claimed in claim 8 wherein the robotic feeder comprises a motor-driven gear assembly which engages the teeth of the rack-shaped insert to displace the robotic feeder along the horizontal crossbar.

10. The system as claimed in claim 9 wherein a charging station is mounted on the frame for recharging the wireless robotic feeder.

11. The system as claimed in claim 5 wherein the robotic feeder comprises:
(a) a liquid food canister for holding a supply of liquid food to be selectively dispensed; and
(b) a dry food dispenser for holding a supply of dry food to be selectively dispensed.

12. The system as claimed in claim 11 wherein the liquid food canister and the dry food dispenser are supported by a head which is adapted to rotate approximately 90 degrees.

13. The system as claimed in claim 11 wherein the dry food dispenser comprises:
(a) a dry food canister shaped to define an interior cavity dimensioned to receive a supply of dry food;
(b) a support bracket adapted to hold the dry food canister;
(c) a metering cap removably coupled the dry food canister;
(d) a rotary motor for selectively rotating the dry food canister; and
(e) a coupler for removably connecting the dry food canister to the motor.

14. The system as claimed in 13 wherein the dry food canister comprises a continuous sidewall, an enclosed bottom end, and an open top end.

15. The system as claimed in claim 14 wherein the metering cap mounts over the open top end of the dry food canister.

16. The system as claimed in claim 15 wherein the metering cap comprises an annular sidewall, a closed front end, and an open rear end, the closed front end having an interior surface and an exterior surface.

17. The system as claimed in claim 16 wherein a transverse trough is integrally formed onto the interior surface of the closed front end in communication with the interior cavity of the dry food canister.

18. The system as claimed in claim 17 wherein the transverse trough is adapted to collect and subsequently dispense a fixed dose of the supply of dry food from the dry food canister through rotation of the dry food canister.
